(19) United States
(12) Patent Application Publication
(10) Pub. No.: US 2018/0267520 A1
(43) Pub. Date: Sep. 20, 2018

(54) METHOD FOR MANUFACTURING PARTS BASED ON SIMULTANEOUS ANALYSIS OF STATISTICAL INDICATORS

(71) Applicant: Safran Aircraft Engines, PARIS (FR)

(72) Inventors: Olivier FERRY, Moissy-Cramayel (FR); Arnaud CAMBEFORT, MOISSY-CRAMAYEL (FR); Pascal COURTIN, MOISSY-CRAMAYEL (FR); Nicolas HARDOUIN, MOISSY-CRAMAYEL (FR); Charles CLERET DE LANGAVANT, MOISSY-CRAMAYEL (FR)

(73) Assignee: Safran Aircraft Engines, PARIS (FR)

(21) Appl. No.: 15/532,482

(22) PCT Filed: Dec. 4, 2015
(86) PCT No.: PCT/FR2015/053326

§ 371 Date: Jun. 1, 2017

(30) Foreign Application Priority Data
Dec. 5, 2014 (FR) 1461990

(51) Int. Cl. G05B 19/418; G06Q 10/06; G06Q 50/04

(52) U.S. Cl. CPC G05B 19/41875; G06Q 10/06395; G05B 2219/32201; G05B 2219/32191; G06Q 50/04

(57) ABSTRACT

The invention relates to a process for manufacturing parts that is based on the simultaneous analysis of a plurality of different statistical indicators representative of a characteristic size of the parts, in which: an overall validation set corresponding to a set-theoretic combination of the various validation sets of each statistical indicator is defined; an overall sanction set corresponding to a set-theoretic combination of the various sanction sets of each statistical indicator is defined; and an overall control set comprising the pairs (μ;σ) not contained in the overall validation set and in the overall sanction set is defined; and it is determined to which overall set, from the overall validation set, the overall sanction set and the overall control set, the pair comprising the mean μₘ and the standard deviation σₘ of the measured characteristic size belongs, and the manufacture is controlled depending on the overall set thus determined.

### FIELD OF THE INVENTION

The invention relates to the use of statistical indicators in an industrial setting, for example, in the aeronautics industry, in particular for facilitating monitoring and control of the manufacturing of parts.

### PRIOR ART

The manufacture of parts, especially mechanical parts, in an industrial setting is met with two opposing constraints: specifically, the increase in manufacturing throughput and volumes on the one hand, and the increased quality requisites on the other, which is particularly true in the aeronautical field.

Today it is difficult to imagine performing quality control on all parts manufactured except to considerably impair manufacturing throughput. Statistical manufacturing indicators are therefore generally used, reliably deducing overall information on the quality of the set of parts manufactured from specific information on the quality of a finite number of parts taken as samples.

Apart from controls at the end of production, which can be done on samples having a limited number of parts, checks are generally also made during production to be able to optionally regulate production flow, that is, adjust manufacturing conditions to ensure that the parts made continue to respond to the required quality criteria. In some cases, these statistical controls during production can result in production stopping completely, especially if the parts produced present excessive quality defects and the manufacturing flow must be completely reinitialised.

Quality controls are performed in relation to a characteristic dimension of the parts that are manufactured. This characteristic dimension can be, for example, a particular side of the part, its mass, or any other measurable characteristic of said parts.

To perform statistical controls, several samples are taken successively, each sample comprising several parts of the manufacturing flow, and the characteristic dimensions of each part of the sample taken are then measured. The value of a statistical indicator selected previously to monitor the quality of the manufacturing flow is calculated from the different measurements of the characteristic dimension of the parts of the sample taken.

There are various statistical indicators, which can be used to monitor the evolution of a manufacturing flow of parts, each statistical indicator giving different information for adjusting the manufacturing conditions in one way or another.

Most statistical indicators used for monitoring an industrial manufacturing process are calculated from an average p and a standard deviation a of the measured characteristic dimension on several parts. More precisely, p corresponds to the average of the decentring measured for the characteristic dimension relative to the reference value for this characteristic dimension.

An example is the centring coefficient, noted Cc, which shows restraint imposed on the variations of the average p inside the tolerance interval IT. The tolerance interval IT is the deviation between the extreme admissible values of the characteristic dimension, therefore being calculated as the difference between the greater tolerance TS and the lesser tolerance TI of the measured characteristic dimension, or IT=TS−TI. The centring coefficient Cc is generally defined by the formula:

$$Cc = \frac{µ}{( TS - TI ) \text{/} 2}$$

The manufacturing process can also be controlled by studying capability indices, which characterise the real performance of the process relative to the preferred performance. Such indices in fact measure the capacity of the manufacturing process to make parts whereof the characteristic dimensions are within the preferred tolerance interval IT.

Reference can be made, for example, to the process capability index Cp, which shows the aptitude of a manufacturing process to produce parts precisely and repeatedly. The larger the capability index Cp and the more the finished parts will be similar, whereas if the capability index Cp is low, production will be scattered. The process capability index Cp is defined generally by the formula:

$$Cp = \frac{( TS - TI ) \text{/} 2}{3 σ}$$

The disadvantage of such a process capability index Cp is that a positive result (that is, high) can also correspond to production outside the limits of tolerance. In fact, the industrial conformity of a manufacturing flow depends on scope, that is not only its dispersion but also the position of its average relative to the tolerance interval IT. Another capability index used is therefore the capability index Cpk, which shows dispersion but also the centring of the production relative to the limits of tolerance. In this case, when the capability index Cpk is high, this means that production can be repeated and that it is also centred in the tolerance interval IT, that is, there will be less risk that parts are manufactured outside tolerances. The capability index Cpk is defined generally by the formula:

$$Cpk = \frac{Min ( TS - µ ; µ - TI )}{3 σ}$$

There are of course other statistical indicators having specific properties, and, which can be used as a function of the needs to regulate the manufacturing process.

One of the practical ways of monitoring these statistical indicators is to use control cards, which are generally in the form of graphics representing time on the abscissa axis and the statistical criterion measured on the ordinate axis. This graphic also displays different zones, of different appearance, each zone corresponding to the result as a function of the value of the statistical indicator measured. There can be, for example, zones of different colours, each colour corresponding to a particular result.

FIG. 1 shows an example of such a graphic control card. The zone V1 corresponding, for example, to a validation zone, that is, if the statistical indicator measured is in this zone, the manufacturing process is validated and the manufacturing flow can be monitored if needed. The zone R1 as such corresponds to a sanction zone, that is if the statistical indicator measured is in this zone there is a major deviation relative to the required quality criteria, and the manufacturing process should be carried out. Generally such a case implies rejection of the finished batch of parts, or even discontinuing the manufacturing process. The zone O1 as such corresponds to an intermediate control zone, which, when the statistical indicator is in this zone, indicates to the user that the parameters of the manufacturing process have to be controlled, and optionally the manufacturing conditions have to be adjusted so as to correct the obvious deviations and recenter them towards the reference values of the characteristic dimension.

A problem occurs when the aim is to monitor several statistical indicators at the same time for the same measured characteristic dimension. An example is the case of a first statistical indicator whereof the control card is illustrated by the graphic shown in FIG. 1, and a second statistical indicator, different to the first, whereof the control card is illustrated by the graphic shown in FIG. 2. In the graphic illustrated in FIG. 2, the notation of zones is similar to that used for the graphic of FIG. 1, specifically where the zone V2 corresponds to the validation zone of the second statistical indicator, the zone O2 corresponds to the control zone of the second statistical indicator, and the zone R2 corresponds to the sanction zone of the second statistical indicator.

But the results of statistical indicators for the same characteristic dimension in a sample taken at a given time can be different. It is evident, for example, that at period no. 4 the second statistical indicator must lead to a sanction whereas the first indicator translates a control action, for the same period.

To best know the overall action to be envisaged in monitoring manufacturing, it is therefore necessary to individually analyse each graphic card of the different statistical indicators and deduce an overall conclusion from the latter, according to the prevailing control rules. But this analysis is very long and is all the longer since there are statistical indicators to be evaluated. This therefore impairs the overall throughput of the manufacturing flow, indirectly involving hikes in manufacturing costs.

An aim of the present invention is therefore to provide a method for the manufacturing of parts based on the analysis of several different statistical indicators representative of a characteristic dimension of parts, which resolves at least one of the above disadvantages.

In particular an aim of the present invention is to provide a method for manufacturing of parts, which enables simultaneous analysis of several different statistical indicators representative of a characteristic dimension of the parts.

Yet another aim of the present invention is to provide a method for manufacturing of parts, which offers increased control of the quality of manufactured parts and maintains high throughput, imposed especially due to industrial manufacturing restrictions.

### SUMMARY OF THE INVENTION

For this purpose, a method for manufacturing parts based on analysis of several different statistical indicators representative of a characteristic dimension of parts is proposed, where:
Each statistical indicator is calculated from an average p and a standard deviation σ of the measured characteristic dimension on several parts produced by a manufacturing device, each statistical indicator being associated with a first reference value and a second reference value greater than the first reference value, defining:
   A validation set comprising the couples (μ;σ) where the statistical indicator is greater than or equal to the second reference value;
   A sanction set comprising the couples (μ;σ) where the statistical indicator is less than or equal to the first reference value; and
   A control set comprising the couples (μ;σ) where the statistical indicator is between the first reference value and the second reference value;
The following are defined:
   an overall validation set corresponding to a setrelated combination of the different validation sets of each statistical indicator;
   an overall sanction set corresponding to a setrelated combination of the different sanction sets of each statistical indicator;
   an overall control set comprising the couples (μ;σ) not included in the overall validation set and in the overall sanction set;
a sample comprising several parts is taken from the parts produced by the manufacturing device, the characteristic dimension of each part of the sample is measured, and an average μₘ and a standard deviation a, of the measured characteristic dimension for the sample taken are calculated;
it is determined for the couple comprising the average μₘ and the standard deviation σₘ of the measured characteristic dimension to which overall set of the overall validation set, the overall sanction set and the overall control set it belongs, and the manufacturing is regulated as a function of the overall set determined in this way, for example, by adjusting the regulating parameters of the manufacturing device.

Each of the steps presented is preferably automated.

The measuring step of the characteristic dimension can be conducted with a measuring device, for example, comprising sensors for performing automated measuring of specific dimensions of the part.

The calculation steps can be taken by any appropriate calculation device, such as, for example, processing computer data means, such as a computer.

The regulating step can be taken, for example, by a regulating device integrating processing means for integrating and processing data originating from the calculation steps so as to correct any anomaly detected in production and correct production flow. In particular, the regulating device is provided to correct the input parameters of the production device from, which parts originated.

The regulating device therefore preferably adjusts the regulating parameters of the manufacturing device used to make the parts, for example, so as to reduce the deviation between the value of one of the statistical indicators and the corresponding reference value.

More generally, the aim is to optimise the deviation between the value of the statistical indicator and the reference value so that production of parts complies with requirements of the relevant specification. The production parameters are modified for modifying, or respectively correcting, the deviation identified between the value of the statistical indicator and the reference value. As a function of the statistical indicator used, optimising the deviation could, for example, consist of reducing the deviation identified.

Preferred, though nonlimiting, aspects of this method, taken singly or in combination, are the following:
determination of the overall set to which the couple comprising the average μₘ and the standard deviation σₘ of the measured characteristic dimension belong is done visually, where:
   the couple is shown comprising the average μₘ and the standard deviation σₘ of the measured characteristic dimension on a regulating graphic (μ;σ) having as abscissa the average μ and as ordinate the standard deviation σ of the representative dimension, on which is displayed:
      A graphic validation zone comprising the couples (μ;σ) of the overall validation set;
      A graphic sanction zone comprising the couples (μ;σ) of the overall sanction set;
      A graphic control zone comprising the couples (μ;σ) of the overall control set;
   The overall associated set is determined as a function of the graphic zone containing said couple.
several samples are taken at different moments, the different couples comprising the average μₘ and the standard deviation σₘ of characteristic dimensions measured for the samples having a representation on the regulating graphic (μ;σ) varying as a function of the moment when the sample has been taken.
the overall validation set corresponds to an intersection of the different validation sets of each statistical indicator, and the overall sanction set corresponds to grouping of the different sanction sets of each statistical indicator.
the overall validation set corresponds to grouping of the different validation sets of each statistical indicator, and the overall sanction set corresponds to an intersection of the different sanction sets of each statistical indicator.
three different statistical indicators are analysed, respectively called first statistical indicator, second statistical indicator, and third statistical indicator, where:
   the overall validation set corresponds to the grouping of the validation set of the first statistical indicator with the intersection between the validation set of the second statistical indicator and the validation set of the third statistical indicator; and
   the overall sanction set corresponds to the intersection between the validation set of the first statistical indicator and the grouping of the validation set of the second statistical indicator with the validation set of the third statistical indicator.
according to the method:
   the first statistical indicator is a first capability index Cpk defined by the formula:

$$Cpk = \frac{Min ( TS - µ ; µ - TI )}{3 σ}$$

the second statistical indicator is a second capability index Cp defined by the formula:

$$Cp = \frac{( TS - TI ) \text{/} 2}{3 σ}$$

the third statistical indicator is a centring coefficient Cc defined by the formula:

$$Cc = \frac{µ}{( TS - TI ) \text{/} 2}$$

where:
   TS is a greater tolerance of the measured characteristic dimension;
   TI is a lesser tolerance of the measured characteristic dimension.
according to the method:
   if it is determined that the couple comprising the average μₘ and the standard deviation σₘ of the measured characteristic dimension belongs to the overall validation set, the manufacturing conditions of the parts are not modified;
   if it is determined that the couple comprising the average μₘ and the standard deviation σₘ of the measured characteristic dimension belongs to the overall sanction set, the manufacturing of parts is discontinued; and
   if it is determined that the couple comprising the average μₘ and the standard deviation σₘ of the measured characteristic dimension belongs to the overall control set, the manufacturing conditions of the parts are adjusted.

### DESCRIPTION OF FIGURES

Other characteristics and advantages of the invention will emerge from the following description, which is purely illustrative and nonlimiting and must be viewed with respect to the attached diagrams, in which:

FIGS. 1 and 2 are graphic representations known from the prior art for monitoring the evolution of an individual statistical indicator;

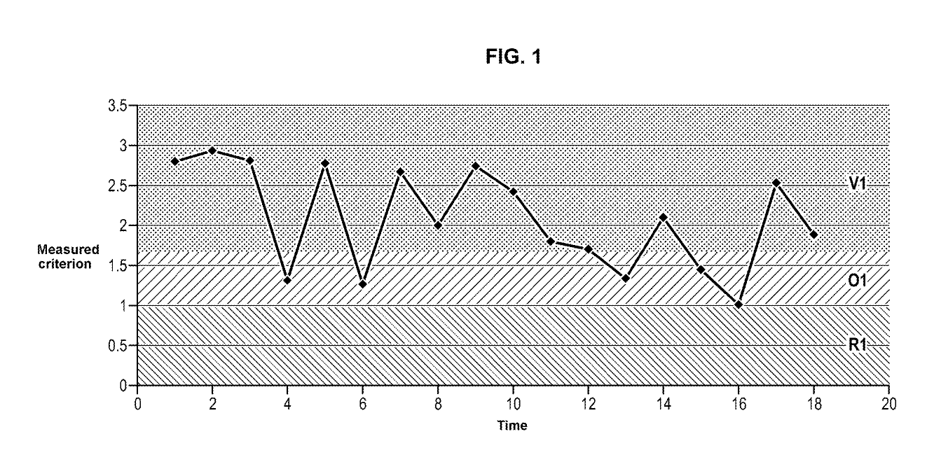

FIG. 3 is a representation of a graphic having as abscissa the average p and as ordinate the standard deviation a of the representative dimension for illustrating a statistical indicator measured relative to a target value of said statistical indicator;

FIG. 4 is a representation of a graphic similar to that of FIG. 3 for illustrating a first statistical indicator measured relative to two reference values of this first statistical indicator for characterising the conformity of a manufacturing method;

FIG. 5 is a representation of a graphic similar to that of FIG. 4 for illustrating a second statistical indicator measured relative to two reference values of this second statistical indicator for characterising the conformity of a manufacturing method;

FIG. 6 is a representation of a regulating graphic according to the invention, integrating set information of the first and second statistical indicators of FIGS. 4 and 5 respectively;

FIGS. 7 and 8 are representations of another regulating graphic according to the invention for monitoring three different statistical indicators.

FIG. 9 is a diagram illustrating a production chain integrating control and regulating of production with sampling of parts.

### DETAILED DESCRIPTION OF THE INVENTION

As specified above, it is frequent for a statistical indicator to be calculated from an average p and a standard deviation a of the measured characteristic dimension on several parts.

As emerges from the above definitions, many statistical indicators depend even exclusively on the average p and the standard deviation a measured on the sample. This is the case in particular of the centring coefficient Cc or the capability indices Cp and Cpk.

It does appear that the set of populations, which can be controlled can be shown by a point located in a halfplane, in which the average p is borne by the axis of abscissa and the standard deviation a by the semiaxis of positive ordinates.

Based on this finding, it is possible for a given criterion C to represent the set of populations verifying the condition C^{measured} (μ, σ)≥C^{target} as a sub-set of this half-plane delimited at its border by the level curve corresponding to the value C^{target} of the function C^{measured} (μ, σ). The rest of the graphic corresponds to the couples (μ;σ) verifying the condition C^{measured} (μ, σ)<C^{target}.

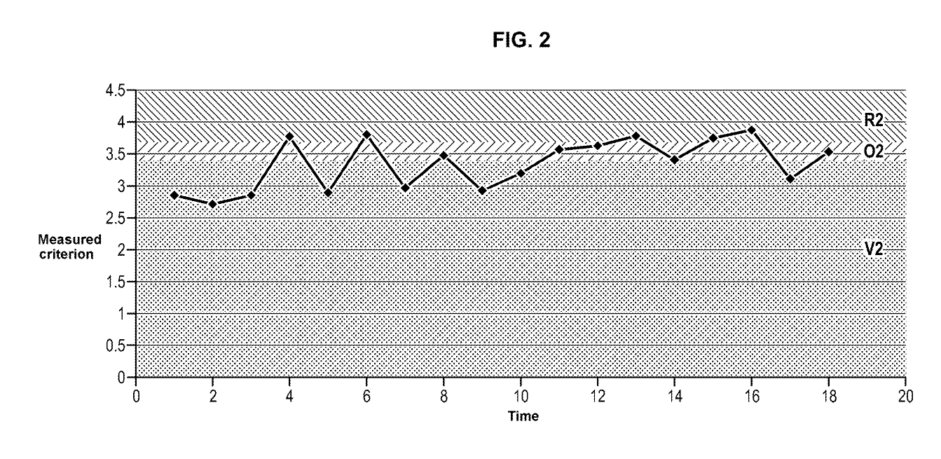

The graphic of FIG. 3 illustrates such a representation of the criterion C.

For monitoring and regulating a manufacturing flow of parts, a statistical indicator is in general associated with two reference values, which define different population sets, that is, different sets of couples (μ;σ) associated with a degree of conformity of the statistical indicator studied.

An example here is a statistical indicator having a first reference value and a second reference value greater than the first reference value, the different conformity sets are defined as follows:
A validation set comprising the couples (μ;σ) where the statistical indicator is greater than or equal to the second reference value;
A sanction set comprising the couples (μ;σ) where the statistical indicator is less than or equal to the first reference value; and
A control set comprising the couples (μ;σ) where the statistical indicator is between the first reference value and the second reference value.

Such a statistical indicator can be illustrated on a graphic in (μ;σ) similar to that of the FIG. 3.

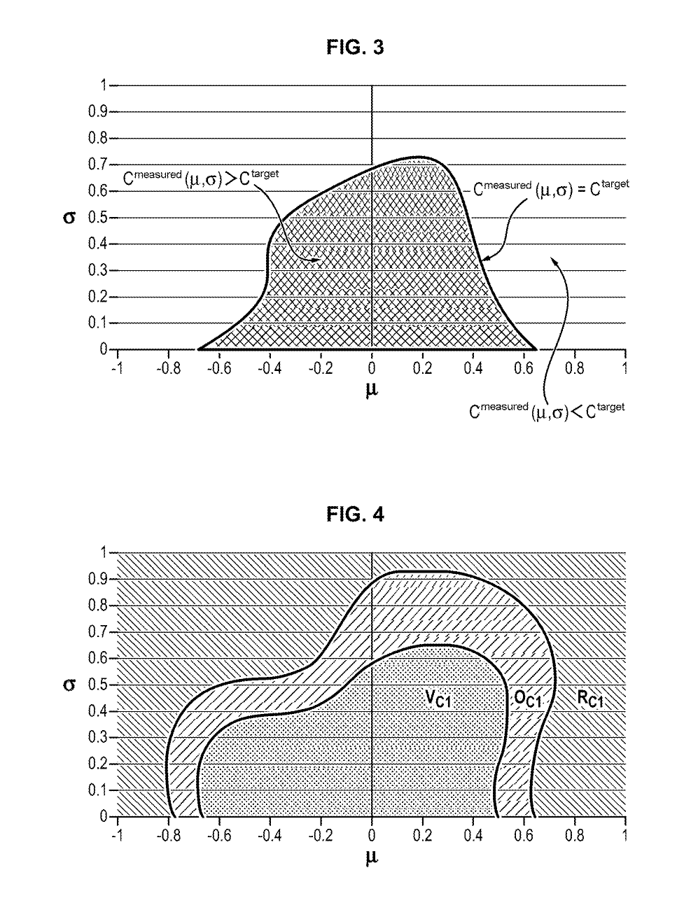

FIG. 4 illustrates, for example, such a graphic for a first indicator C₁(μ, σ), where the graphic zone V_{C1} combines the couples (μ;σ) of the validation set of the indicator C₁(μ, σ), the graphic zone R_{C1} combines the couples (μ;σ) of the sanction set of the indicator C₁(μ, σ), and the graphic zone O_{C1} combines the couples (μ;σ) of the control set of the indicator C₁(μ, σ).

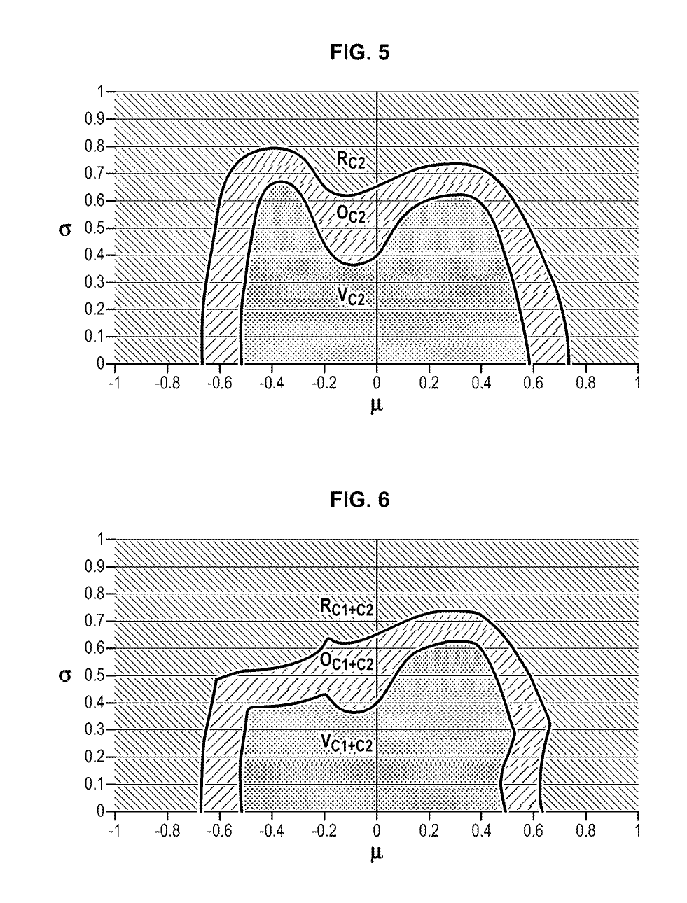

FIG. 5 illustrates such a graphic for a second indicator C₂(μ, σ), where the graphic zone V_{C2} combines the couples (μ;σ) of the validation set of the indicator C₂(μ, σ), the graphic zone R_{C2} combines the couples (μ;σ) of the sanction set of the indicator C₂(μ, σ), and the graphic zone O_{C2} combines the couples (μ;σ) of the control set of the indicator C₂(μ, σ).

A validation zone is preferably shown graphically by a green zone, a sanction zone is shown by a red zone, and a control zone is shown by an orange zone.

In this case, C₁^{VGreen/Orange} and C₁^{Orange/Red} are the first and second reference values of the first statistical indicator respectively, and C₂^{Green/Orange} and C₂^{Orange/Red} are the first and second reference value of the second statistical indicator respectively.

The green (corresponding to a validation zone), orange (corresponding to a control zone) and red (corresponding to a sanction zone) zones of the monitoring graphics of the statistical indicators and can also be defined as follows:

Green Zone₁={(μ; σ)∈R×R₊|C₁(μ, σ)≥C₁^{Green/Orange}}

Orange Zone₁={(μ; σ)∈R×R₊|C₁^{Orange/Red}≤C₁(μ, σ)<C₁^{Green/Orange}}

Red Zone₁={(μ; σ)∈R×R₊|C₁(μ, σ)<C₁^{Orange/Red}}

and

Green Zone₂={(μ; σ)∈R×R₊|C₁(μ, σ)≥C₂^{Green/Orange}}

Orange Zone₂={(μ; σ)∈R×R₊|C₂^{Orange/Red}≤C₂(μ, σ)<C₂^{Green/Orange}}

Red Zone₂={(μ; σ)∈R×R₊|C₁(μ, σ)<C₂^{Orange/Red}}

Such a set approach is particularly advantageous when the aim is to monitor several statistical indicators simultaneously.

In fact, one can define different overall sets from the various sets of each statistical indicator, which represent levels of conformity integrating the restrictions of several statistical criteria. So the following are preferably defined:
an overall validation set corresponding to a setrelated combination of the different validation sets of each statistical indicator;
an overall sanction set corresponding to a setrelated combination of the different sanction sets of each statistical indicator;
an overall control set comprising the couples (p;a) not included in the overall validation set and in the overall sanction set;

In this way, after having taken a sample comprising several parts of the manufacturing flow, the characteristic dimension of each part of the sample is measured; an average μₘ and a standard deviation σₘ of the measured characteristic dimension for the sample taken are calculated, before determining to which overall set among the aforementioned sets of conformity the couple comprising the average p, and the standard deviation a, of the measured characteristic dimension belongs.

The manufacturing flow can then be regulated as a function of the overall set determined in this way.

For example, if it is determined that the couple comprising the average μₘ and the standard deviation σₘ of the measured characteristic dimension belong to the overall validation set, it is considered that the manufacturing flow complies with manufacturing requirements, and the manufacturing conditions of the parts are therefore not modified.

If it is determined that the couple comprising the average μₘ and the standard deviation σₘ of the measured characteristic dimension belongs to the overall sanction set, this means that there is a significant deviation between the measured characteristic dimension on the sample taken and the manufacturing requirements. In this case, manufacturing of the parts can be discontinued, for example, to reinitialise the manufacturing flow.

If it is determined that the couple comprising the average μₘ and the standard deviation σₘ of the measured characteristic dimension belongs to the overall control set, this means that there is the risk of deviation with the reference values, and that the manufacturing flow therefore has to be monitored with more attention, or even the manufacturing conditions of the parts have to be adjusted.

Determining the overall set to which the couple comprising the average μₘ and the standard deviation σₘ of the measured characteristic dimension belong, is preferably done visually. A monitor on which control information is displayed could be used in this respect, for example.

For this to occur, a regulating graphic (μ;σ) can be used for example, having as abscissa the average μ and as ordinate the standard deviation σ of the representative dimension, on which is displayed:

A graphic validation zone comprising the couples (μ;σ) of the overall validation set;

A graphic sanction zone comprising the couples (μ;σ) of the overall sanction set;

A graphic control zone comprising the couples (μ;σ) of the overall control set.

The couple comprising the average μₘ and the standard deviation σₘ of the measured characteristic dimension can then be shown on this regulating graphic. The overall set associated with this couple (μ;σ) is determined simply as a function of the graphic zone containing said couple.

The set combinations forming the overall sets depend on restrictions imposed on the manufacturing method.

According to an embodiment, the overall validation set corresponds to an intersection of the different validation sets of each statistical indicator, and the overall sanction set corresponds to grouping of the different sanction sets of each statistical indicator.

According to another embodiment, the overall validation set corresponds to grouping of the different validation sets of each statistical indicator, and the overall sanction set corresponds to an intersection of the different sanction sets of each statistical indicator.

The example hereinabove is referred to again, where the conformity zones are respectively green, orange and red zones. When the two statistical indicators C₁(μ, σ) and C₂(μ, σ) must be monitored simultaneously and are calculated from the same measurements, it is possible to define an overall Red zone, an Orange zone and a Green zone by:

Green Zone=Green Zone₁∩Green Zone₂

Orange Zone=(Green Zone₁∩Orange Zone₂)∪(Orange Zone₁∩Green Zone₂)∪(Orange Zone₁∩Orange Zone₂)

Red Zone=Red Zone₁∪Red Zone₂

According to this example where the aim is to monitor the conjunction of two indicators, the overall green zone to be taken into account is the intersection of the two green zones of each of the two indicators, the overall red zone is the grouping of the two red zones of each of the two indicators, and the orange zone comprises the rest of the halfplane (μ;σ).

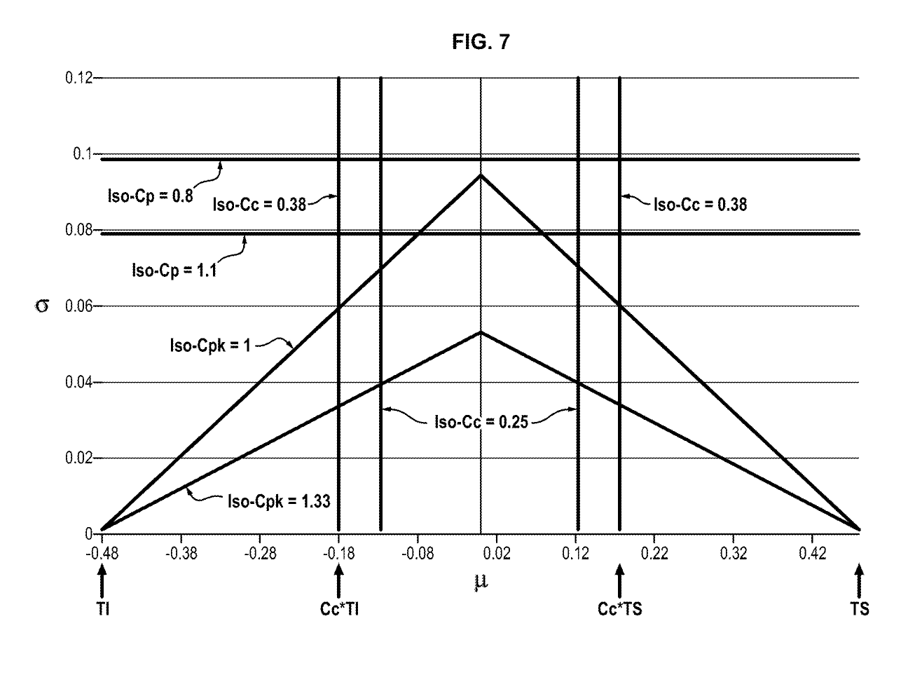

Graphically, this can be illustrated in a halfplane (μ;σ) as in FIG. 6, where the graphic zone V_{C1+C2} combines the couples (μ;σ) of the overall validation set (Green zone), the graphic zone R_{C1+C2} combines the couples (μ;σ) of the overall sanction set (Red zone), and the graphic zone O_{C1+C2} combines the couples (μ;σ) of the overall control set (Orange zone).

Such a regulating graphic alone synthetically monitors the two indicators and sets a level of conformity of the values measured, simply by positioning on the graphic the couple comprising the average μₘ and the standard deviation σₘ of the measured characteristic dimension, the average values and standard deviation calculated during measuring.

The general case consists of simultaneous monitoring of n indicators C₁(μ, σ), C₂(μ, σ), . . . , Cᵢ(μ, σ) having for each indicator i a (validation zone), a Orange Zoneᵢ (control zone) and a Red Zoneᵢ (sanction zone) delimited by the values Cᵢ^{Green/Orange} and Cᵢ^{Orange/Red}, and consequently defined by:

Green Zoneᵢ={(μ; σ)∈R×R₊|C₁(μ,σ)≥C₁^{Green/Orange}}

Orange Zoneᵢ={(μ; σ)∈R×R₊|C₁^{Orange/Red}≤C₁(μ,σ)≤C₁^{Green/Orange}}

Red Zoneᵢ={(μ; σ)∈R×R₊|C₁(μ, σ)<C₁^{Orange/Red}}

In the event where the overall validation set corresponds to an intersection of the different validation sets of each statistical indicator, and the overall sanction set corresponds to grouping of the different sanction sets of each statistical indicator, this results graphically as follows:

Green Zone=∩ᵢ₌₁ⁿ(Green Zoneᵢ)

Red Zone=∪ᵢ₌₁ⁿ(Red Zoneᵢ)

Orange Zone=R×R₊\(Green Zone∪Red Zone)

The graphic (μ;σ) therefore replaces graphs by a single one, giving overall synthetic and immediate conformity of the status of production monitored at a given instant by way of tools used in statistical processes.

Particular more complex cases can be also processed similarly.

The following is an example of a manufacturing process monitored with three statistical indicators C₁(μ, σ), C₂(μ, σ) and C₂(μ, σ). In the event where validation rules enable validation of either the indicator C₁(μ, σ), or alternatively the conjunction of indicators C₂(μ, σ) and C₃(μ, σ), the overall green, orange and red zones to be shown are:

Green Zone=Green Zone₁∪(Green Zone₂∩Green Zone₃)

Red Zone=Red Zone₁∩(Red Zone₂∪Red Zone₃)

Orange Zone=R×R₊\(Green Zone∪Red Zone)

For monitoring an industrial flow of manufacturing of parts, this tracking process can be applied, for example, by considering that the first statistical indicator C₁(μ, σ) corresponds to the capability index Cpk, the second statistical indicator C₂(μ, σ) corresponds to the capability index Cp, and the third statistical indicator C₃(μ, σ) corresponds to the centring coefficient Cc.

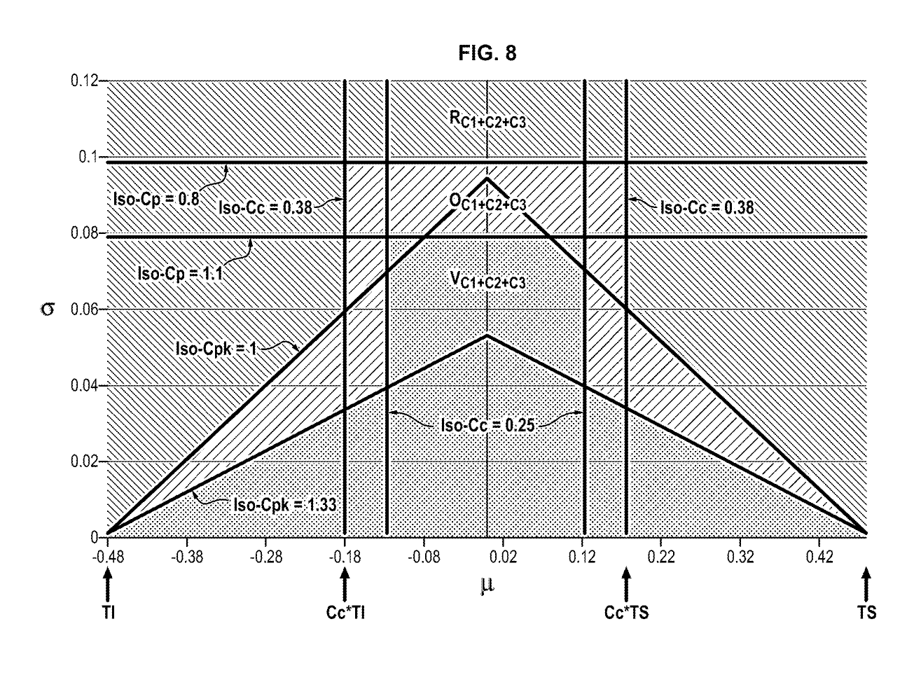

The iso-values of these three indicators are shown very simply in the diagram (p;a) as illustrated in FIGS. 7 and 8, where:
The iso-Cc are shown by vertical straight lines cutting the axis of abscissa at points Cc*TI and Cc*TS;
The iso-Cp are shown as horizontal straight lines cutting the axis of ordinates at point IT/(3*Cp);
The iso-Cpk are shown as inclined straight lines cutting the axis of abscissa at points TI and TS, and the slope of, which is all the greater since the imposed Cpk is low.

FIG. 8 shows the graphic with the different conformity zones according to the set combinations given as example hereinabove. The Green zone is noted V_{C1+C2+C3}, the Orange zone is noted O_{C1+C2+C3}, and the Red zone is noted R_{C1+C2+C3}.

By way of advantage, a specific representation of the couples (μₘ;σₘ) of the characteristic dimensions measured for samples taken successively over time could also be provided.

A representation on the regulating graphic (μ; σ) of the couple (μₘ;σₘ), which varies as a function of the moment when the sample was taken can also be provided for example. In this way graphic regulating also represents a time dimension for the purpose of chronological monitoring and production regulation period after period.

A possible solution consists of chronologically hierarchising the markers each representing measurements taken successively, by giving them different sizes and colours., for example, markers having an increasingly smaller size and becoming increasingly less opaque as they correspond to an earlier measurement can be used.

The method proposed could be performed in a manufacturing chain of parts, which can be fully or partially automated, where controls during production regulate the manufacturing flow, that is, adjust the manufacturing conditions to ensure that the finished parts continue to respond to the required quality criteria.

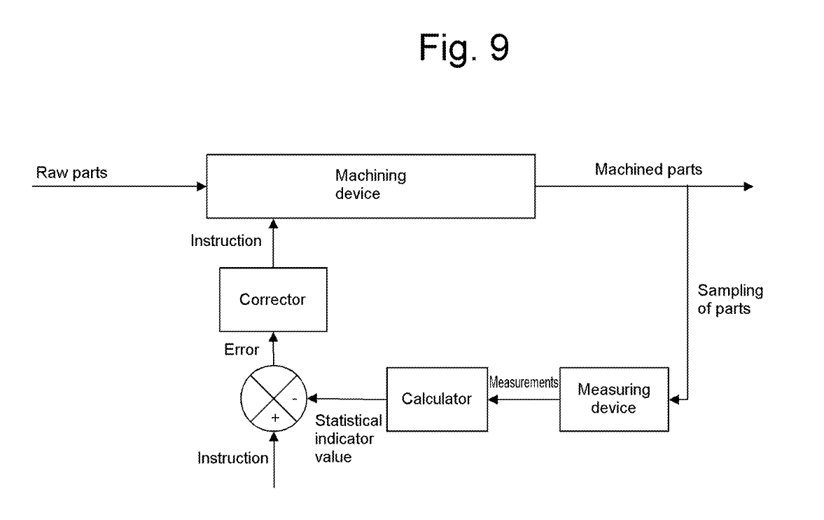

FIG. 9 gives an example of such a manufacturing chain in which a machining device, such as, for example, a 5axle machine, is used to make parts according to a specific instruction. The specific instruction can, for example, relate to a particular characteristic dimension. In place of the machining device, a manufacturing device not limited to the machining of parts could of course be used.

In this automated production chain, parts are sampled when exiting the machining device to form a sample and sent to a measuring device, which measures one or more characteristic dimensions of each part of the sample taken. Such a measuring device can, for example, be a three-dimensional measuring machine having sensors, which automatically measure the preferred characteristic dimensions of each of the parts.

The measurement data coming from the measuring device are then sent to a calculation device, which processes them to calculate one or more statistical indicators representative of one of the characteristic dimensions of the parts.

The calculated value of the statistical indicator is then compared to a reference instruction on the characteristic dimension so as to manage the manufacturing flow. More precisely, the results of this comparison optionally adjust the input parameters of the machining device. In this case, the reference instruction is defined by the overall validation set, the overall sanction set and the overall control set.

If a deviation is evident, implying an error, for example, if the value of the statistical indicator on the characteristic dimension is outside an acceptable range defined by the reference instruction, corrective measurements are determined by a corrector to adjust the input parameters of the machining device. The aim of modifications to the input parameters of the machining device is to correct the evident deviation so that the value of the statistical indicator on the characteristic dimension is back within an acceptable range.

1. A method for manufacturing parts produced with a manufacturing device, based on simultaneous analysis of several different statistical indicators representative of a characteristic dimension of the parts, where:
Each statistical indicator is calculated from an average μ and a standard deviation σ of the measured characteristic dimension over several parts, each statistical indicator being associated with a first reference value and a second reference value greater than the first reference value, defining:
a validation set comprising the couples (μ;σ) where the statistical indicator is greater than or equal to the second reference value;
a sanction set comprising the couples (μ;σ) where the statistical indicator is less than or equal to the first reference value; and
a control set comprising the couples (μ;σ) where the statistical indicator is between the first reference value and the second reference value;
The following are defined:
an overall validation set corresponding to a setrelated combination of the different validation sets of each statistical indicator;
an overall sanction set corresponding to a setrelated combination of the different sanction sets of each statistical indicator;
an overall control set comprising the couples (μ;σ) not included in the overall validation set and in the overall sanction set;
a sample comprising several parts is taken from the parts produced by the manufacturing device, the characteristic dimension of each part of the sample is measured, and an average μₘ and a standard deviation σₘ of the measured characteristic dimension are calculated for the sample taken;
which overall set among the overall validation set, the overall sanction set and the overall control set the couple comprising the average μₘ and the standard deviation σₘ of the measured characteristic dimension belongs to is determined, and the manufacturing is operated as a function of the overall set determined in this way.

2. The method as claimed in claim 1, in which determination of the overall set to which the couple comprising the average μₘ and the standard deviation σₘ of the measured characteristic dimension belongs is done visually, where:
the couple comprising the average μₘ and the standard deviation σₘ of the measured characteristic dimension is represented on a regulating graphic (μ;σ) having as abscissa the average μ and as ordinate the standard deviation σ of the representative dimension, on which is displayed:
a graphic validation zone comprising the couples (μ;σ) of the overall validation set;
a graphic sanction zone comprising the couples (μ;σ) of the overall sanction set;
a graphic control zone comprising the couples (μ;σ) of the overall control set;
The overall associated set is determined as a function of the graphic zone inside, which is said couple.

3. The method as claimed in claim 2, in which several samples are taken at different moments, the different couples comprising the average μₘ and the standard deviation σₘ of the characteristic dimensions measured for the samples having a representation on the regulating graphic (μ;σ) varying as a function of the moment when the sample has been taken.

4. The method as claimed in claim 2, in which the regulating graphic (μ;σ) is displayed on a monitor.

5. The method as claimed in claim 1, in which the overall validation set corresponds to an intersection of the different validation sets of each statistical indicator, and the overall sanction set corresponds to grouping of the different sanction sets of each statistical indicator.

6. The method as claimed in claim 1, in which the overall validation set corresponds to grouping of the different validation sets of each statistical indicator, and the overall sanction set corresponds to an intersection of the different sanction sets of each statistical indicator.

7. The method as claimed in claim 1, in which three different statistical indicators are analysed, respectively called first statistical indicator, second statistical indicator, and third statistical indicator, where:
the overall validation set corresponds to the grouping of the validation set of the first statistical indicator with the intersection between the validation set of the second statistical indicator and the validation set of the third statistical indicator; and
the overall sanction set corresponds to the intersection between the validation set of the first statistical indicator and the grouping of the validation set of the second statistical indicator with the validation set of the third statistical indicator.

8. The method as claimed in claim 7, in which:
the first statistical indicator is a first capability index Cpk defined by the formula:
$$Cpk = \frac{Min ( TS - µ ; µ - TI )}{3 σ}$$
the second statistical indicator is a second capability index Cp defined by the formula:
$$Cp = \frac{( TS - TI ) \text{/} 2}{3 σ}$$
the third statistical indicator is a centring coefficient Cc defined by the formula:
$$Cc = \frac{µ}{( TS - TI ) \text{/} 2}$$
where:
TS is a greater tolerance of the measured characteristic dimension;
TI is a lesser tolerance of the measured characteristic dimension.

9. A method for manufacturing parts produced with a manufacturing device, based on simultaneous analysis of several different statistical indicators representative of a characteristic dimension of the parts, where:
Each statistical indicator is calculated from an average μ and a standard deviation σ of the measured characteristic dimension over several parts, each statistical indicator being associated with a first reference value and a second reference value greater than the first reference value, defining:
a validation set comprising the couples (μ;σ) where the statistical indicator is greater than or equal to the second reference value;
a sanction set comprising the couples (μ;σ) where the statistical indicator is less than or equal to the first reference value; and
a control set comprising the couples (μ;σ) where the statistical indicator is between the first reference value and the second reference value;
The following are defined:
an overall validation set corresponding to a setrelated combination of the different validation sets of each statistical indicator;
an overall sanction set corresponding to a setrelated combination of the different sanction sets of each statistical indicator;
an overall control set comprising the couples (μ;σ) not included in the overall validation set and in the overall sanction set;
a sample comprising several parts is taken from the parts produced by the manufacturing device, the characteristic dimension of each part of the sample is measured, and an average μₘ and a standard deviation σₘ of the measured characteristic dimension are calculated for the sample taken;
which overall set among the overall validation set, the overall sanction set and the overall control set the couple comprising the average μₘ and the standard deviation σₘ of the measured characteristic dimension belongs to is determined, and the manufacturing is operated as a function of the overall set determined in this way, such that:
if it is determined that the couple comprising the average μₘ and the standard deviation σₘ of the measured characteristic dimension belongs to the overall validation set, the manufacturing conditions of the parts are not modified;
if it is determined that the couple comprising the average μₘ and the standard deviation σₘ of the measured characteristic dimension belongs to the overall sanction set, the manufacturing of the parts is discontinued; and
if it is determined that the couple comprising the average μₘ and the standard deviation σₘ of the measured characteristic dimension belongs to the overall control set, the manufacturing conditions of the parts are adjusted by adjusting the regulating parameters of the manufacturing device.
